(19) United States
(12) Patent Application Publication
(10) Pub. No.: US 2019/0156353 A1
(43) Pub. Date: May 23, 2019

(54) METHOD AND SYSTEM FOR DISCRETIONARY CALL FORWARDING AND REROUTING

(71) Applicants: Koby Jackson, Kaysville, UT (US); Brock Jackson, Kaysville, UT (US)

(72) Inventors: Koby Jackson, Kaysville, UT (US); Brock Jackson, Kaysville, UT (US)

(21) Appl. No.: 16/194,371

(22) Filed: Nov. 18, 2018

Related U.S. Application Data
(60) Provisional application No. 62/588,371, filed on Nov. 19, 2017.

(51) Int. Cl. G06Q 30/02; G06F 17/27; G06Q 10/10

(52) U.S. Cl. CPC G06Q 30/0201; G06Q 10/10; G06F 17/2785

(57) ABSTRACT

A method for connecting a customer and employee, the method comprising; receiving, by one or more computing devices, an inquiry from a customer, analyzing, by one or more computing devices, the content of the inquiry, providing, by one or more computing devices, the inquiry to a preselected employee based on the analyzed content of the inquiry, determining, by one or more computing devices, the preselected employee is available and if the preselected employee is not available providing, by one or more computing devices, at least one other employee, connecting the employee and the customer, and providing the employee with the analyzed content from the inquiry.

### CROSS-REFERENCE TO RELATED APPLICATIONS

This application is a continuation and claims the benefit of priority under 35 USC 120 of U.S. application No. 62/588,371 filed on Nov. 19, 2017. The disclosure of the prior applications is considered part of (and is incorporated by reference in) the disclosure of this application.

### BACKGROUND

This disclosure relates generally call forwarding, and more specifically to a method, computer program, and computer system efficiently forwarding called to personnel based on expertise.

As telecommunications systems advance, demand increases for routing parties together in the fastest, most efficient form possible. One example of a subscriber feature that is commonly used is call-forwarding. Conventional call-forwarding systems enable telephone calls directed to a particular dialing number or PBX extension number to be redirected or forwarded to another dialing number. In particular, a subscriber may program a telephone service such that any telephone call placed to the subscriber's dialing number Will automatically be rerouted to a forward-to number chosen by the subscriber, thereby causing the telephone at the forwarded number to ring.

Call forwarding (also known as call diverting) is a feature available on some telephone networks that allows an incoming call to a particular dialed number (e.g., associated with a particular device) to be redirected to a mobile telephone or another telephone number (e.g., where the called party is actually located). Call forwarding may be an integral feature of some phone systems that provide an integrated docking station (e. g., for a smartphone) with a telephone device. For example, when a user removes a mobile phone from a docking station associated with an office phone, calls to both the mobile and office phones may automatically be routed to the mobile phone.

However, the call forwarding process has not been improved upon in where the call is directed to. For example, when a call is transferred it is likely to be transferred to the first available recipient if there are more than one regardless of their ability to assist the person, or the recipient does not have the necessary information about the caller to properly help them or has to spend time learning about what the caller is interested in learning. Current routing systems are slow, do not provide the necessary information to the recipient, and typically result in lost interest by the caller.

Therefore, it is desired for a method, computer program, or computer system to route callers to the most appropriate recipient to provide the caller with an efficient use of time, connecting them with a knowledgeable recipient, and improving the call forwarding process.

### SUMMARY

The present invention provides an embodiment of a method for connecting a customer and employee, the method comprising: receiving, by one or more processors, an inquiry from a customer; analyzing, by one or more processors, the content of the inquiry; providing, by one or more processors, the inquiry to a preselected employee based on the analyzed content of the inquiry; determining, by one or more processors, the preselected employee is available and if the preselected employee is not available providing, by one or more processors, at least one other employee; connecting, by one or more processors, the employee and the customer; and providing, by one or more processors the employee with the analyzed content from the inquiry.

The present invention provides another embodiment of a computer program product for connecting a customer and employee, the method comprising: one or more computer readable storage media and program instructions stored on the one or more computer readable storage media, the program instructions comprising: program instructions to receive an inquiry from a customer; program instructions to analyze the content of the inquiry; program instructions to provide the inquiry to a preselected employee based on the analyzed content of the inquiry; program instructions to determine the preselected employee is available and if the preselected employee is not available program instructions to provide at least one other employee; program instructions to connect the employee and the customer; and program instructions to provide the employee with the analyzed content from the inquiry.

The present invention provides yet another embodiment of a computer system for connecting a customer and employee, the method comprising: one or more computer processors, one or more computer readable storage media, and program instructions stored on the one or more computer readable storage media for execution by, at least one of the one or more processors, the program instructions comprising: program instructions to receive an inquiry from a customer; program instructions to analyze the content of the inquiry; program instructions to provide the inquiry to a preselected employee based on the analyzed content of the inquiry; program instructions to determine the preselected employee is available and if the preselected employee is not available program instructions to provide at least one other employee; program instructions to connect the employee and the customer; and program instructions to provide the employee with the analyzed content from the inquiry.

### BRIEF DESCRIPTION OF THE DRAWINGS

FIG. 1 depicts a block diagram depicting a computing environment, in accordance with one embodiment of the present invention.

FIG. 2 depicts a flowchart of the operational steps taken by a connection program when an inquiry is received, in accordance with an embodiment of the present invention.

FIG. 3 depicts a flowchart of the operational steps taken by the connection program to establish communication between the inquisitor and the assistor, in accordance with an embodiment of the present invention.

FIG. 4 depicts a block diagram depicting the internal and external components of a computing device or a server of FIG. 1, in accordance with one embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects may generally be referred to herein as a “circuit,” “module”, or “system.” Furthermore, aspects of the present invention may take the form of a computer program product embodied in one or more computer readable medium(s) having computer readable program code/instructions embodied thereon.

An advantage of the present invention is the ability to analyze incoming calls (or electronic communications), routing them to the desired personnel, and connecting the two parties in as short a time frame as possible. When receiving inquiries from customers, the speed at which the company's personnel respond to the customers inquiries and their ability to quickly and accurately answer their inquiries directly affects the sales and likelihood of accomplishing the sale increases. For example, in the automotive industry, industry studies show that 78% of prospects do business with the first party to make contact. This value further increases based on the speed and accountability by the business if communication is established within one minute of the submission of the inquiry.

The present invention will now be described in detail with reference to the Figures.

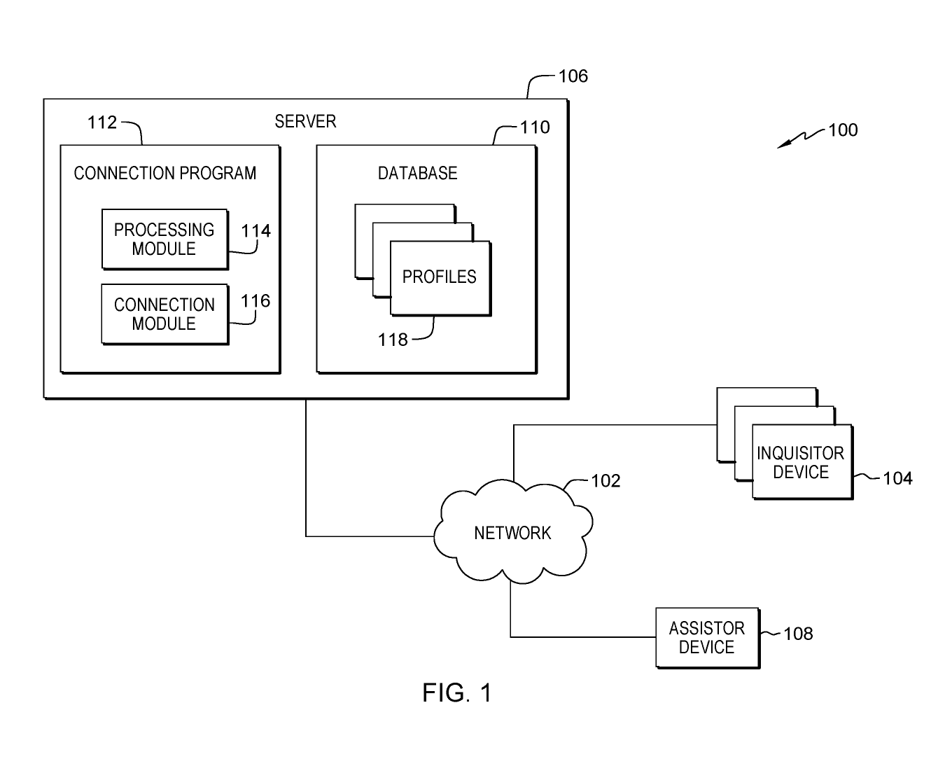

FIG. 1 depicts a block diagram of a computing environment 100 in accordance with one embodiment of the present invention. FIG. 1 provides an illustration of one embodiment and does not imply any limitations regarding the environment in which different embodiments maybe implemented.

In the depicted embodiment, computing environment 100 includes network 102, inquisitor device 104, assistor device 108, and server 106. Computing environment 100 may include additional servers, computers, or other devices not shown.

Network 102 may be a local area network (LAN), a wide area network (WAN) such as the Internet, any combination thereof, or any combination of connections and protocols that can support communications between inquisitor device 104, and server 106 in accordance with embodiments of the invention. Network 102 may include wired, wireless, or fiber optic connections. The network 102 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 102 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 102 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

Inquisitor device(s) 104 comprise one or more computing devices which can receive input from the inquisitor and transmit and receive data via network 102. The inquisitor devices 104 may be any other electronic device or computing system capable of processing program instructions and receiving and sending data. In one embodiment, the inquisitor devices 104 is a conventional computer system executing, for example, a Microsoft Windows compatible operating system (OS), Apple OS X, and/or a Linux distribution. In another embodiment, the inquisitor devices 104 can be a device having computer functionality, such as a smart-phone, a tablet, a personal digital assistant (PDA), a mobile telephone, etc. In some embodiments, inquisitor devices 104 may be a laptop computer, tablet computer, netbook computer, personal computer (PC), a desktop computer, or any programmable electronic device capable of communicating with and server 106 and assistor device 108 via network 102. In other embodiments, inquisitor devices 104 may represent a server computing system utilizing multiple computers as a server system, such as in a cloud computing environment. In another embodiment, inquisitor devices 104 represents a computing system utilizing clustered computers and components to act as a single pool of seamless resources.

Assistor device(s) 108 comprise one or more computing devices which can receive input from the inquisitor and transmit and receive data via network 102. The Assistor device(s) 108 may be any other electronic device or computing system capable of processing program instructions and receiving and sending data. In one embodiment, the Assistor device(s) 108 is a conventional computer system executing, for example, a Microsoft Windows compatible operating system (OS), Apple OS X, and/or a Linux distribution. In another embodiment, the Assistor device(s) 108 can be a device having computer functionality, such as a smart-phone, a tablet, a personal digital assistant (PDA), a mobile telephone, etc. In some embodiments, Assistor device(s) 108 may be a laptop computer, tablet computer, netbook computer, personal computer (PC), a desktop computer, or any programmable electronic device capable of communicating with and inquisitor device 104 and server 106 via network 102. In other embodiments, Assistor device(s) 108 may represent a server computing system utilizing multiple computers as a server system, such as in a cloud computing environment. In another embodiment, Assistor device(s) 108 represents a computing system utilizing clustered computers and components to act as a single pool of seamless resources.

Server 106 may be a management server, a web server, or any other electronic device or computing system capable of processing program instructions and receiving and sending data. In another embodiments server 106 may be a laptop computer, tablet computer, netbook computer, personal computer (PC), a desktop computer, or any programmable electronic device capable of communicating via network 102. In one embodiment, server 106 may be a server computing system utilizing multiple computers as a server system, such as in a cloud computing environment. In one embodiment, server 106 represents a computing system utilizing clustered computers and components to act as a single pool of seamless resources. In the depicted embodiment, connection program 112 is located on server 108. Server 108 may include components, as depicted and described in further detail with respect to FIG. 7.

In one embodiment, the Assistor device 108 interacts with server 106 through an application programming interface or application, such as iOS and ANDROID. The computing device 108 may display content through the processing of markup language and displaying this information through the connection program 112. The connection program 112 displays the identified content collected from the image capturing component of the connection program 112 using the format or presentation described by the markup language. Examples of the markup language are extensible markup language (XML) data, extensible hypertext markup language (XHTML) data, or other markup language data. The connection program 112 may also include the ability to process JavaScript Object Notation (JSON) data, JSON with padding (JSONP), and JavaScript data to facilitate data-interchange between computing device 108 and the server 106. In other embodiments, computing device 108 may include any combination of connection program 112, processing module 114, and connection module 116.

Database 114 may be a repository that may be written to and/or read by computing device 108 or various components. The data collected and processed by the connection program 112 as well as other data associated may be stored in database 114. Such information may include user information, user release forms, user data, and other account/user features and information. In one embodiment, database 114 is a database management system (DBMS) used to allow the definition, creation, querying, update, and administration of a database(s). In the depicted embodiment, database 114 resides within server 106. In other embodiments, database 114 resides on another server, or another computing device, provided that database 114 is accessible by the connection program 112 and its components.

connection program 112 and its components function to gather the raw data from the documents, process the raw data, determine if a request is made, and processing the request for the authorized documents. The connection program 112 takes a release form, extracts the data from the release form, including the signature, and stores the data. Then when a release form needs to be issued, a user can request a specific person's account and have an authorized release form issued. In the depicted embodiment, connection program 112 has a plurality of modules to perform specific functions of the programs design. Various modules may be included to complete these functions. In the depicted embodiment, connection program 112 resides on computing device 108 and utilizes network 102 to access server 106. In one embodiment, connection program 112 resides on a separate server, such as server 108. In other embodiments, connection program 112 may be located on another server, computing device, or exist in a cloud computing system provided connection program 112 has access to database 106, the processing module 114, and the connection module 116.

Database 118 may be a repository that may be written to and/or read by connection program 112. Information associated with the information or data generated by connection program 112 may be stored to database 118. Such information may include user account information, account activity, account relationships, and other account features. In one embodiment, database 118 is a database management system (DBMS) used to allow the definition, creation, querying, update, and administration of a database(s). In the depicted embodiment, database 118 resides on server 108. In other embodiments, database 118 resides on another server, or another computing device, provided that database 118 is accessible to connection program 112.

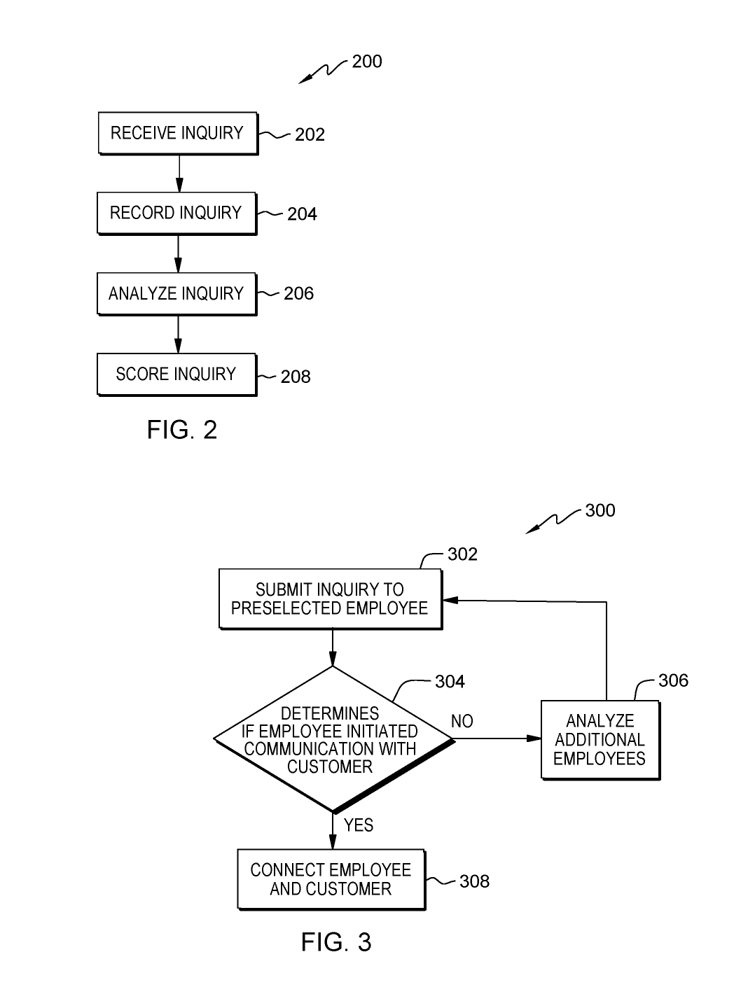

FIG. 2 depicts a flowchart of the operational steps taken by the processing module 114, in accordance with one embodiment of the present invention. It should be appreciated by one skilled in the art that FIG. 2 provides only an illustration of one implementation and does not imply any limitations with regard to the environments in which different embodiments may be implemented. Many modifications to the depicted environment may be made.

The connection program 112 is designed to receive inquiries, process the details from the inquiry, and connect the customer with a preselected employee based on the inquiry details and the employee specialties.

In step 202, processing module 114 receives and inquiry from a potential customer. The inquiry may be, but not limited, to a phone call, a survey submission, an electronic request, or other forms of telephonic, or electronic submissions to a company to inquiry or purchase a product. In some embodiments, the inquiry is received by a customer visiting the client's webpage or accessing their online. In another embodiment, based on specific content the customer accesses activate the inquiry request.

In step 204, processing module 114 records the inquiry. In embodiments, where the inquiry is a phone call, the audio of the phone call is recorded and stored in the database for further review. In some embodiments, where the inquiry is an audio recording, the recording is transcribed by natural language processing to create a textual representation of the context of the inquiry.

In step 206, processing module 114 analyzes the inquiry. The inquiry is analyzed to determine the content of the inquiry for routing purposes. In some embodiments, if the inquiry is an audio file, a natural language processing may be performed to extract the content of the inquiry. In further embodiments, the speech of the customer is analyzed to determine various characteristics of the customer for routing purposes. For example, speech patterns, accents, inflection in their voice, and various features may be analyzed so that when rerouted a specific employee is selected. In some embodiments, where the inquiry is a textual document, the processing module 114 analyzes the form for specific and predetermined information. In some embodiments, the processing module 114 analyzes the inquiry based on the actions of the customer on the company's content to determine the customer's inquiry. For example, if the client is viewing a dealerships inventory and repeatedly looks a specific make or model, processing module 114 analyzes this information and determines the content of the customers inquiry. In additional embodiments, various types of cognitive computing can be implemented to better determine the content of the inquiry for rerouting purposes.

In one embodiment, the processing module 114 uses information life cycle management to manage the information associated with the inquiry. This may be, but not limited to, the use of cognitive computing functions to process the metadata associated with the inquiry, the customer's practices from past inquiries, and additional information that is processed based on computer learning technologies. In some embodiments, a hierarchical storage management system may be employed.

In additional embodiments, the analysis of the inquiry may determine, based on the use of natural language processing or artificial intelligence, the context of the inquiry. The analysis to determine the content, can then further be used to create a searchable version of the inquiry, or build triggers or tags which are reported to the preselected employee or used to review past inquiries. In some embodiments, the inquiries are reviewed and through artificial intelligence or the like, is assessed predetermined positive and negative words/context, or sections of the inquiry.

In step 208, the processing module 114 scores the inquiry based on predetermined characteristics and the analysis of the inquiry. For example, an inquiry where it is analyzed to have a negative context is likely to be scored specifically, and similar if an inquiry is analyzed to have a positive context. These scores assist in localizing areas which need continued improvement, or areas which have improved.

FIG. 3 depicts a flowchart of the operational steps taken by the connection module 116, in accordance with one embodiment of the present invention. It should be appreciated by one skilled in the art that FIG. 3 provides only an illustration of one implementation and does not imply any limitations with regard to the environments in which different embodiments may be implemented. Many modifications to the depicted environment may be made.

In step 302 connection module 116 sends the inquiry to a predetermined employee. Based on the analyzed inquiry, a predetermined set of features are used to determine the most appropriate employee for the customer to be connected with. Each employee has a predetermined set of characteristics, strengths, weaknesses associated with them within the system so that when the connection module 116 sends the inquiry, the desired employee is selected initially. For example, if an inquiry is related to a specific make and model one employee may have a higher degree of education on that make or model, which would allow him to better assist the customer. Where another employee would need to spend time educating themselves on the make or model. In another example, if the customer makes note that they prefer to work with women or men, this would assist in removing employee's which the customer would not prefer to work with, thereby creating a more comfortable experience for the customer. In some embodiments, more than one employee is provided with the inquiry to further increase the opportunity for the customer to quickly and efficiently connect with an employee.

In some embodiments, each employee has resume or set of predetermined information that is used to assist the connection module 116 in determining which employee is best for the received inquiry.

In some embodiments, when the inquiry is sent to the employee, additional information is provided to the employee to further educate themselves on the customers inquiry, so they are able to quickly and efficiently answer any immediate questions the customer may have. This information may be presented to the employee in a predetermined method such as a breakdown of the inquiry, or a textual representation of the phone call. In some embodiments, this information may be color coated based on areas which are determined to be more important or relevant based on the analyses of the inquiry.

In decision 304, connection module 116 determines if the employee received the inquiry. For various reasons and situations an employee maybe away from their desk, phone, or computer. In many industries it is vital that an inquiry be responded to in seconds otherwise the customer may go elsewhere. If the employee does not accept the inquiry within a predetermined time frame (NO branch, proceed to step 306), the connection module 116 analyzes additional employees. If the employee does accept the inquiry (YES branch, proceed to step 304), the customer and the employee are connected, and the employee is provided with the additional information to best assist the customer with their inquiry. In some embodiments, the communication is automatically created. In additional embodiments, the employee needs to complete the connection by accomplishing a task, e.g. picking up the phone or pressing a predetermined number or code.

In step 308, connection module 116 analyzes additional personnel to connect with the customer. connection module 116 determines, based on a predetermined score of the remaining employees, who are known to be available, to connect with the customer. In one embodiment, each of the employees are assigned a score based on the inquiry information, and the employees are selected based on this score. In additional embodiments, if only one employee is available, they are connected with the customer to assist in answering their inquiries.

In some embodiments, if no employees are available, the connection module 116 routes the customer to a voicemail or recording service to leave their contact information and questions so an employee may communicate with the customer when available.

In step 306, connection module 116 connects the employee and the customer to discuss the matter. In some embodiments, the information about the inquiry is supplied to the employee to view and review while communicating with the customer.

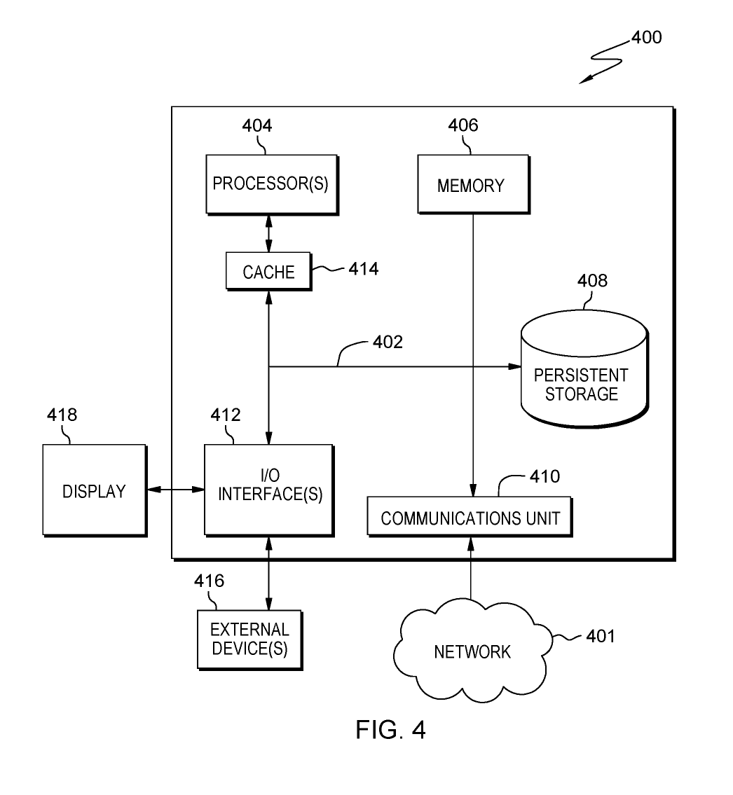

FIG. 4 depicts a block diagram 400 of components of a computing device (e.g. networking service 104, user device 106, and/or server 108), in accordance with an illustrative embodiment of the present invention. It should be appreciated that FIG. 1 provides only an illustration of one implementation and does not imply any limitations with regard to the environments in which different embodiments may be implemented. Many modifications to the depicted environment may be made. It should be appreciated FIG. 1 provides only an illustration of one implementation and does not imply any limitations with regard to the environments in which different embodiments may be implemented.

Computing environment 400 is, in many respects, representative of the various computer subsystem(s) in the present invention. Accordingly, several portions of computing environment 400 will now be discussed in the following paragraphs.

Computing device 400 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any additional hardware components within a system. For example, communications fabric 402 can be implemented with one or more buses.

Computing device 400 is capable of communicating with other computer subsystems via network 401. Network 401 can be, for example, a local area network (LAN), a wide area network (WAN) such as the Internet, or a combination of the two, and can include wired, wireless, or fiber optic connections. In general, network 401 can be any combination of connections and protocols that will support communications between computing device 400 and other computing devices.

Memory 406 and persistent storage 408 are computer-readable storage media. In one embodiment, memory 406 includes random access memory (RAM) and cache memory 414. In general, memory 406 can include any suitable volatile or non-volatile computer-readable storage media.

Memory 406 is stored for execution by one or more of the respective computer processors 404 of computing device 400 via one or more memories of memory 406 of computing device 400. In the depicted embodiment, persistent storage 408 includes a magnetic hard disk drive. Alternatively, or in addition to a magnetic hard disk drive, persistent storage 408 can include a solid-state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in the examples, provides for communications with other data processing systems or devices, including computing device 400. In the examples, communications unit 410 includes one or more network interface cards. Communications unit 410 may provide communications through the use of either or both physical and wireless communications links.

I/O interface(s) 412 allows for input and output of data with other devices that may be connected to computing device 400. For example, I/O interface 412 may provide a connection to external devices 416 such as a keyboard, keypad, camera, a touch screen, and/or some other suitable input device. External devices 416 can also include portable computer-readable storage media such as, for example, thumb drives, portable optical or magnetic disks, and memory cards. Software and data used to practice embodiments of the present invention, can be stored on such portable computer-readable storage media and can be loaded onto persistent storage 408 of computing device 400 via I/O interface(s) 412 of computing device 400. Software and data used to practice embodiments of the present invention, can be stored on such portable computer-readable storage media and can be loaded onto persistent storage 408 of computing device 400 via I/O interface(s) 412 of computing device 400. I/O interface(s) 412 also connect to a display 418.

Display 418 provides a mechanism to display data to a patient and may be, for example, a computer monitor.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the patient's computer, partly on the patient's computer, as a stand-alone software package, partly on the patient's computer and partly on a remote computer or entirely on the remote computer or server. In the latter scenario, the remote computer may be connected to the patient's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

What is claimed is:

1. A method for connecting a customer and employee, the method comprising:
receiving, by one or more processors, an inquiry from a customer;
analyzing, by one or more processors, the content of the inquiry;
providing, by one or more processors, the inquiry to a preselected employee based on the analyzed content of the inquiry;
determining, by one or more processors, the preselected employee is available and if the preselected employee is not available providing, by one or more processors, at least one other employee;
connecting, by one or more processors, the employee and the customer; and
providing, by one or more processors the employee with the analyzed content from the inquiry.

2. The method of claim 1, further comprising recording, by one or more processors, the inquiry.

3. The method for connecting a customer and employee of claim 2, wherein the recording is transcribed, by one or more processors, wherein the transcription is performed by a natural language processing.

4. The method of claim 2, further comprising, analyzing, by one or more processors, the inquiry to determine positive or negative context.

5. The method of claim 4, wherein the determined positive or negative context, further comprising, scoring, by one or more processors, the inquiry based on the context.

6. The method of claim 5, further comprising, categorizing, by one or more processors, the content of the inquiry.

7. The method for connecting a customer and employee of claim 5, further comprising, categorizing, by one or more processors, the context of the inquiry, with predetermined and specific tags, wherein when the inquiry is being analyzed and a tag is discovered, the inquiry is marked at the time or duration of the inquiry.

8. A computer program product for connecting a customer and employee, the method comprising:
one or more computer readable storage media and program instructions stored on the one or more computer readable storage media, the program instructions comprising:
program instructions to receive an inquiry from a customer;
program instructions to analyze the content of the inquiry;
program instructions to provide the inquiry to a preselected employee based on the analyzed content of the inquiry;
program instructions to determine the preselected employee is available and if the preselected employee is not available program instructions to provide at least one other employee;
program instructions to connect the employee and the customer; and
program instructions to provide the employee with the analyzed content from the inquiry.

9. The computer program product of claim 8, further comprising program instructions to record content of the inquiry.

10. The computer program product of claim 9, further comprising, program instructions to transcribe the recording, wherein the transcription is performed by a natural language processing.

11. The computer program product of claim 9, further comprising, program instructions to analyze the inquiry to determine positive or negative context.

12. The computer program product of claim 11, wherein the determined positive or negative context, further comprising, program instructions to score the inquiry based on the context.

13. The computer program product of claim 12, further comprising, program instructions to categorize, the content of the inquiry.

14. The computer program product of claim 12, further comprising, program instructions to associate, the context of the inquiry, with predetermined and specific tags, wherein when the inquiry is being analyzed and a tag is discovered, the inquiry is marked at the time or duration of the inquiry.

15. A computer system for connecting a customer and employee, the method comprising:
one or more computer processors, one or more computer readable storage media, and program instructions stored on the one or more computer readable storage media for execution by, at least one of the one or more processors, the program instructions comprising:
program instructions to receive an inquiry from a customer;
program instructions to analyze the content of the inquiry;
program instructions to provide the inquiry to a preselected employee based on the analyzed content of the inquiry;
program instructions to determine the preselected employee is available and if the preselected employee is not available program instructions to provide at least one other employee;
program instructions to connect the employee and the customer; and
program instructions to provide the employee with the analyzed content from the inquiry.

16. The computer system of claim 15, further comprising program instructions to record content of the inquiry.

17. The computer system of claim 16, further comprising, program instructions to transcribe the recording, wherein the transcription is performed by a natural language processing.

18. The computer system of claim 16, further comprising, program instructions to analyze the inquiry to determine positive or negative context.

19. The computer system of claim 18, wherein the determined positive or negative context, further comprising, program instructions to score the inquiry based on the context.

20. The computer system of claim 19, further comprising, program instructions to categorize, the content of the inquiry.
